(19) United States
(12) Patent Application Publication
(10) Pub. No.: US 2019/0004722 A1
(43) Pub. Date: Jan. 3, 2019

(54) STORAGE ACCESS CONTROL DEVICE, STORAGE ACCESS CONTROL SYSTEM, STORAGE ACCESS CONTROL METHOD, AND RECORDING MEDIUM IN WHICH STORAGE ACCESS CONTROL PROGRAM IS STORED

(71) Applicant: NEC PLATFORMS, Ltd., Kawasaki-shi, Kanagawa (JP)

(72) Inventor: Kozue TAKEDA, Kanagawa (JP)

(73) Assignee: NEC PLATFORMS, Ltd., Kawasaki-shi, Kanagawa (JP)

(21) Appl. No.: 16/066,761

(22) PCT Filed: Jan. 19, 2017
(86) PCT No.: PCT/JP2017/001674

§ 371 Date: Jun. 28, 2018

(30) Foreign Application Priority Data
Jan. 22, 2016 (JP) 2016-010472

(51) Int. Cl. G06F 3/06; G06F 12/10

(52) U.S. Cl. CPC G06F 3/0631; G06F 3/0604; G06F 3/0652; G06F 2212/657; G06F 12/10; G06F 2212/1044; G06F 3/0673

(57) ABSTRACT

A storage access control device 30 is provided with: a storage unit 32 that stores area management information 320 indicating, regarding a state of each of physical storage areas in a storage device 40, any of a standby state, an active state, a format state, and a free state; a formatting execution unit 31 that formats any of the physical storage areas in the free state before the physical storage area is allocated as the logical storage area; an allocation control 33 unit that allocates, upon occurrence of access to a specific logical storage area(s) of the logical storage areas to which none of the physical storage areas is allocated, a first one of the physical storage areas in the standby state as the specific logical storage area; and an update unit 34 that updates the area management information 320 according to processing performed on the physical storage area.

### TECHNICAL FIELD

The present invention relates to a technology for controlling access to a storage device that needs formatting processing.

### BACKGROUND ART

In a highly information-oriented modern society, storage devices such as redundant arrays of inexpensive disks (RAID) that store a large volume of data are used at various scenes. Regarding such a storage device, a technology for improving performance of access to stored data is expected.

As one example of the technology, PTL 1 discloses a storage system that considers differences in performance and function between a plurality of storage control devices, a distance between a plurality of storage control devices, or the like. In this system, controllers provided in a first storage control device and a second storage control device are connected to each other via a connection medium having a maximum communication distance longer than that of a connection medium of the same type as an internal bus of the controller. In this system, the first storage control device virtualizes a logical volume provided in the second storage control device, and provides the logical volume for one or more host devices connected to the first storage control device. In this system, the second storage control device virtualizes a logical volume provided in the first storage control device, and provides the logical volume for one or more host devices connected to the second storage control device.

PTL 2 discloses a storage control device that allocates a real storage area to a virtual volume in chunk units each including a plurality of pages. When load bias occurs between RAID groups, the storage control device reallocates data.

PTL 3 discloses a system for formatting a high-density data storage medium such as a magneto-optical disk in accordance with distribution time criteria, not formatting all at once. This system reduces time needed to store data in the data storage medium by eliminating a need to delete data at a time of a writing request to the data storage medium.

### CITATION LIST

### Patent Literature

[PTL 1] Japanese Unexamined Patent Application Publication No. 2014-209364

[PTL 2] Japanese Unexamined Patent Application Publication (Translation of PCT Application) No. 2012-531653

[PTL 3] Japanese Unexamined Patent Application Publication No. H08(1996)-152974

### SUMMARY OF INVENTION

### Technical Problem

A storage device such as a RAID forms a virtual medium binding a plurality of physical disks (hereinafter referred to as a “pool”) and constructs logical disks generated by dividing an area of the pool. Such a storage device allocates any of storage areas in a physical disk group forming the pool as a logical disk and then performs formatting processing on the storage area in the physical disk group. After completion of the formatting processing, a host device such as a server device accessing such a storage device can make write access to the logical disk.

Protection information is generally added to data stored in a storage device in such a way as to increase reliability. T10-Data Integrity Field (DIF) stipulated by Standardization Organization T10 and the like have been known as the protection information. FIG. 16 is a diagram illustrating an example of a configuration of data using T10-DIF. As illustrated in FIG. 16, 8 bytes of DIF (protection information) are added to every 512 bytes in T10-DIF. DIF includes 16 bits of a guard tag (GRD) field, 16 bits of an application tag (APP) field, and 32 bits of a reference tag (REF) field. A Logical Sector Number (LSN) being a sector number of a logical disk is generally used as the REF field. Therefore, the above-described formatting processing is usually performed after a logical disk is generated.

FIG. 17 is a diagram for schematically describing an example of allocating a part of a physical disk group 52 (pool) as a logical disk 51 in a general storage device 50 (storage device without using a thin provisioning technology to be described later). As illustrated in FIG. 17, a capacity of a physical disk having a predetermined capacity of a logical disk is allocated as a logical disk regardless of an actual amount of data in the storage device 50.

FIG. 18 is a time chart of storage access control processing performed on the storage device 50 by a general storage access control device (not illustrated). As illustrated in FIG. 18, the storage access control device successively executes construction of a pool, generation of a logical disk, and formatting processing. A host device (not illustrated) capable of accessing the storage device 50 may issue a writing request to a logical address in a storage area that has not yet undergone the formatting processing. In this case, the storage access control device needs to perform the formatting processing while processing the writing request.

FIG. 19 is a diagram for schematically describing an example of allocating a part of a physical disk group 62 as a logical disk 61 in a storage device 60 using a thin provisioning technology. In the storage device 50 illustrated in FIG. 17, a capacity of a physical disk having a predetermined capacity of a logical disk including a storage area being not actually used is allocated as a logical disk. Accordingly, there is a problem that a great amount of waste occurs in the physical disk. The thin provisioning technology is a technology that has been developed in order to solve such a problem. As illustrated in FIG. 19, a capacity of a physical disk having an actual amount of data is allocated as a logical disk in the storage device 60.

FIG. 20 is a time chart of storage access control processing performed on the storage device 60 by a general storage access control device (not illustrated). As illustrated in FIG. 20, the storage access control device successively executes construction of a pool, generation of a logical disk, and formatting processing. A host device (not illustrated) capable of accessing the storage device 60 may issue a writing request to a logical address in a storage area that has not yet been allocated as a logical disk. In this case, the storage access control device needs to allocate a physical disk as a logical disk in the storage area and also perform the formatting processing on the storage area while processing the writing request.

As described above, in the storage access control processing on the storage devices illustrated in FIGS. 17 to 20, when a writing request is generated in regard to a logical address in a storage area that has not undergone the formatting processing, the formatting processing needs to be performed while the writing request is processed. In this case, there is a problem that performance of responding to write access to the storage device decreases. PTLs 1 to 3 do not mention this problem. A main object of the present invention is to provide a storage access control device and the like solving this problem.

### Solution to Problem

A storage access control device according to one aspect of the present invention includes: a formatting execution means for performing formatting processing on at least any of a plurality of physical storage areas in a storage device before the physical storage area is allocated as a logical storage area accessible from a host device accessing the storage device; a storage means for storing area management information indicating a state of each of the physical storage areas as to whether or not the physical storage area has been allocated as any of a plurality of the logical storage areas and whether or not the formatting processing has been executed; an allocation control means for allocating, upon occurrence of access by the host device to a specific logical storage area(s) of the logical storage areas to which none of the plurality of physical storage areas has been allocated, a first one of the physical storage areas in a standby state as the specific logical storage area, the standby state indicating in the area management information that the physical storage area has not yet been allocated as the logical storage area and that the formatting processing has been executed; and an update means for updating the area management information stored in the storage means according to processing performed on the physical storage area by the formatting execution means and the allocation control means.

From another perspective to achieve the object described above, a storage access control method according to one aspect of the present invention includes, by an information processing device: performing formatting processing on at least any of a plurality of physical storage areas in a storage device before the physical storage area is allocated as a logical storage area accessible from a host device accessing the storage device; storing, in a storage means, area management information indicating a state of each of the physical storage areas as to whether or not the physical storage area has been allocated as any of a plurality of the logical storage areas and whether or not the formatting processing has been executed; allocating, upon occurrence of access by the host device to a specific logical storage area(s) of the logical storage areas to which none of the plurality of physical storage areas has been allocated, a first one of the physical storage areas in a standby state as the specific logical storage area, the standby state indicating in the area management information that the physical storage area has not yet been allocated as the logical storage area and that the formatting processing has been executed; and updating the area management information stored in the storage means according to processing performed on the physical storage area.

Further, from still another perspective to achieve the object described above, a storage access control program according to one aspect of the present invention causes a computer accessible to a storage means for storing area management information indicating a state of each of physical storage areas in a storage device as to whether or not the physical storage area has been allocated as any of a plurality of logical storage areas accessible from a host device accessing the storage device and whether or not formatting processing has been executed, to execute: formatting execution processing of performing the formatting processing on at least any of the plurality of physical storage areas before the physical storage area is allocated as the logical storage area; allocation control processing of allocating, upon occurrence of access by the host device to a specific logical storage area(s) of the logical storage areas to which none of the plurality of physical storage areas has been allocated, a first one of the physical storage areas in a standby state as the specific logical storage area, the standby state indicating in the area management information that the physical storage area has not yet been allocated as the logical storage area and that the formatting processing has been executed; and update processing of updating the area management information stored in the storage means according to processing performed on the physical storage area by the formatting execution processing and the allocation control processing.

In addition, the present invention may also be achieved by a computer-readable non-volatile recording medium in which the storage access control program (computer program) is stored.

### Advantageous Effects of Invention

The present invention can improve performance of responding to write access to a storage device that needs formatting processing.

### BRIEF DESCRIPTION OF DRAWINGS

FIG. 1 is a block diagram illustrating a configuration of a storage access control system 1 according to a first example embodiment of the present invention;

FIG. 2 is a diagram exemplifying a configuration of area management information 120 according to the first example embodiment of the present invention;

FIG. 3 is an example of a state transition diagram concerned with a VLDN according to the first example embodiment of the present invention;

FIG. 4A is a diagram (1/2) illustrating an example of setting the area management information 120 according to the first example embodiment of the present invention;

FIG. 4B is a diagram (2/2) illustrating an example of setting the area management information 120 according to the first example embodiment of the present invention;

FIG. 5 is a diagram illustrating an example of an initial state of the area management information 120 according to the first example embodiment of the present invention;

FIG. 6 is a diagram illustrating a first example of updating the area management information 120 according to the first example embodiment of the present invention;

FIG. 7 is a diagram illustrating a second example of updating the area management information 120 according to the first example embodiment of the present invention;

FIG. 8 is a diagram illustrating a third example of updating the area management information 120 according to the first example embodiment of the present invention;

FIG. 9 is a diagram illustrating a fourth example of updating the area management information 120 according to the first example embodiment of the present invention;

FIG. 10 is a diagram illustrating a fifth example of updating the area management information 120 according to the first example embodiment of the present invention;

FIG. 11 is a flowchart illustrating an operation when the storage access control device 10 according to the first example embodiment of the present invention performs formatting processing on a VLDN at predetermined timing;

FIG. 12 is a flowchart illustrating an operation when the storage access control device 10 according to the first example embodiment of the present invention receives a writing request to the storage device 20 from the host device 2;

FIG. 13 is a flowchart illustrating an operation when the storage access control device 10 according to the first example embodiment of the present invention receives a request to delete a logical disk or reduce a storage capacity thereof from the host device 2;

FIG. 14 is a block diagram illustrating a configuration of a storage access control device 30 according to a second example embodiment of the present invention;

FIG. 15 is a block diagram illustrating a configuration of an information processing device capable of executing the storage access control device according to each of the example embodiments of the present invention;

FIG. 16 is a diagram illustrating an example of a configuration of data using T10-DIF;

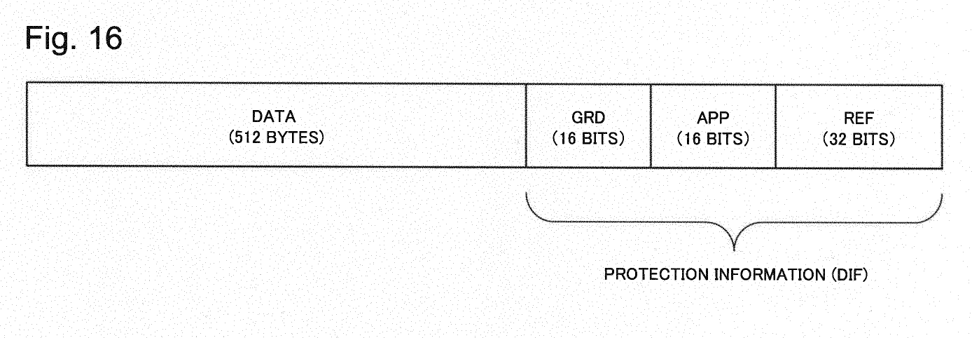

FIG. 17 is a diagram for schematically describing an example of allocating a physical disk as a logical disk in a general storage device without using a thin provisioning technology;

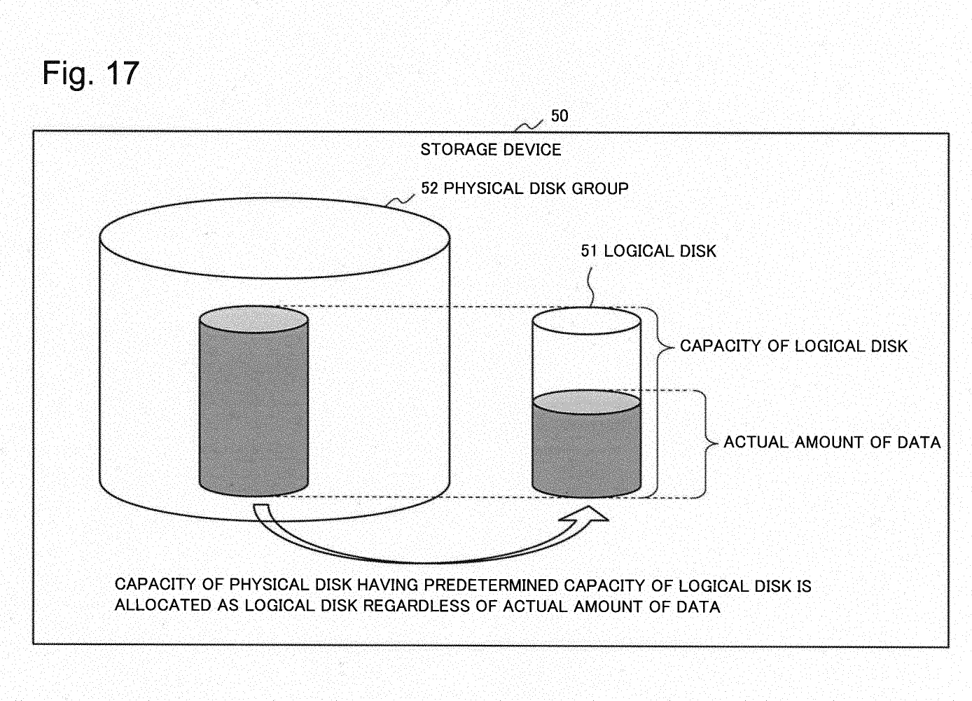

FIG. 18 is a time chart of storage access control processing performed on the storage device without using the thin provisioning technology by a general storage access control device;

FIG. 19 is a diagram for schematically describing an example of allocating a physical disk as a logical disk in a general storage device using the thin provisioning technology;

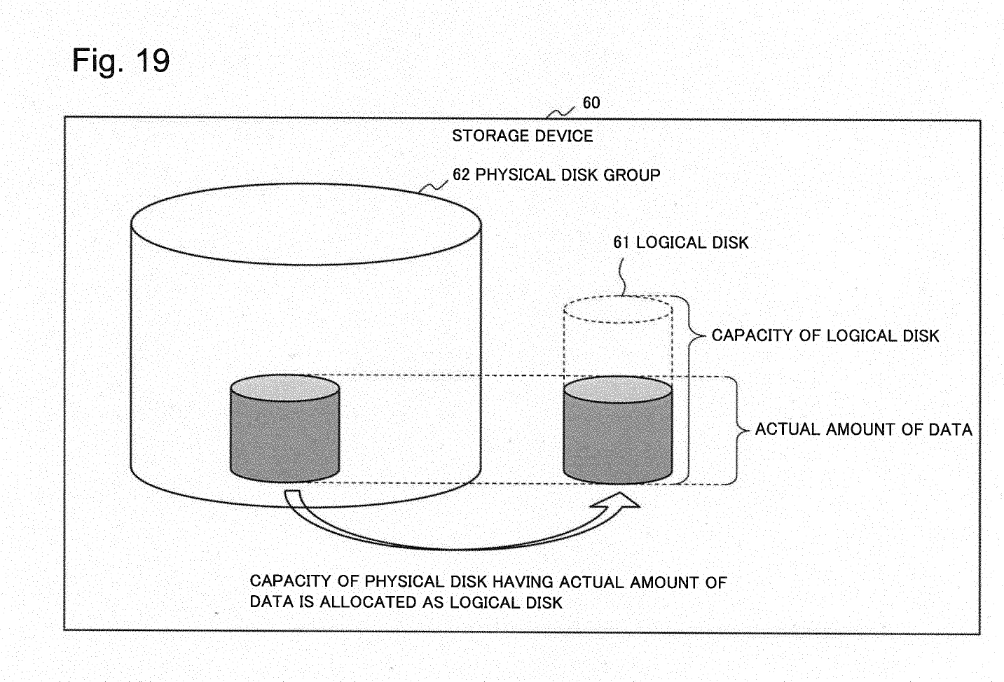

FIG. 20 is a time chart of storage access control processing performed on the storage device using the thin provisioning technology by a general storage access control device; and

FIG. 21 is a time chart of storage access control processing performed by the storage access control device 10 according to the first example embodiment of the present invention.

### DESCRIPTION OF EMBODIMENTS

Hereinafter, example embodiments of the present invention will be described in detail with reference to drawings.

### First Example Embodiment

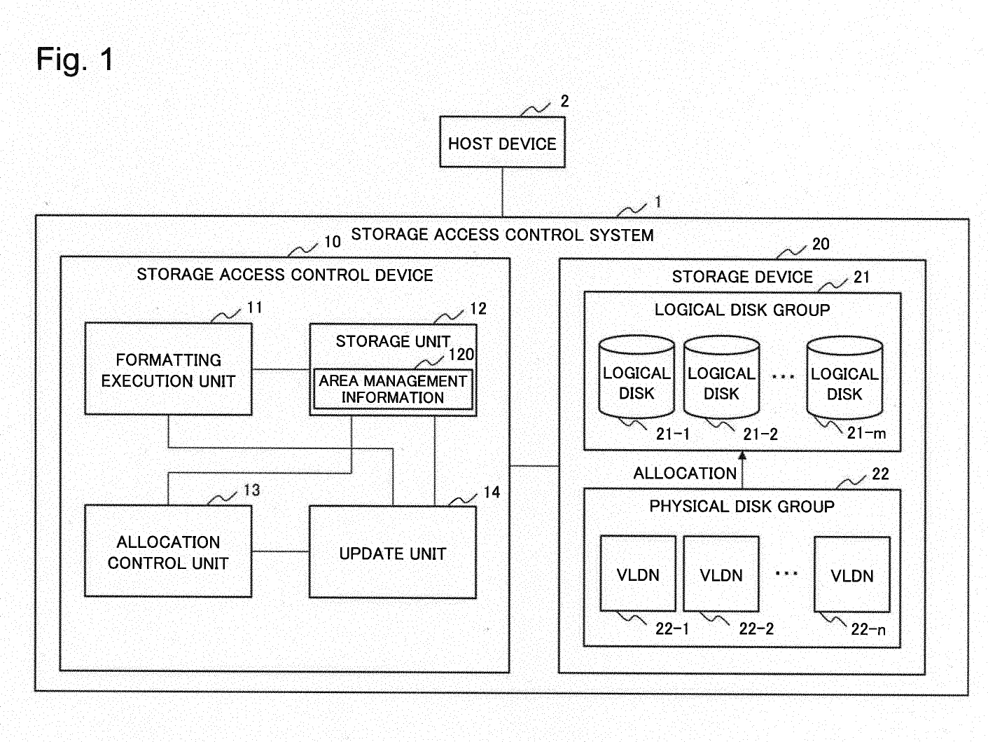

FIG. 1 is a block diagram schematically illustrating a storage access control system 1 according to a first example embodiment of the present invention. Broadly speaking, the storage access control system 1 includes a storage access control device 10 and a storage device 20. The storage access control system 1 is communicably connected to a host device 2. The host device communicably connected to the storage access control system 1 may be a plurality of host devices. The storage access control device 10 is a device that processes a request to read data and a request to write data to the storage device 20 from the host device 2. The storage access control system 1 may be constructed as a storage device formed of one housing.

The storage device 20 stores data used by the host device 2. The storage device 20 includes a physical disk group 22 including one or more physical disks. m (m is an arbitrary integer of two or more) logical disks 21-1 to 21-m included in a logical disk group 21 are generated from any of storage areas in the physical disk group 22 being allocated by the storage access control device 10. An address (logical address) designated by the host device 2 when accessing the storage device 20 is an address in the logical disk group 21. Conversion from a logical address in the logical disk group 21 into a physical address in the physical disk group 22 is performed by the storage access control device 10 having an address converting function.

The storage access control device 10 according to the present example embodiment includes a formatting execution unit 11, a storage unit 12, an allocation control unit 13, and an update unit 14. The formatting execution unit 11, the allocation control unit 13, and the update unit 14 are achieved by an electronic circuit in some cases and also by a computer program and a processor operating according to the computer program in other cases. The storage unit 12 is a storage device such as a memory and a magnetic disk. The storage unit 12 has a storage control function achieved by an electronic circuit or by a computer program and a processor operating according to the computer program.

The storage access control device 10 according to the present example embodiment constructs a pool by the physical disk group 22 and then manages a storage area having a predetermined size as a management unit in the physical disk group 22. In the present example embodiment, this management unit is referred to as a virtual logical disk number (VLDN). The physical disk group 22 according to the present example embodiment includes n (n is an arbitrary integer of two or more) VLDNs 22-1 to 22-n. The VLDNs 22-1 to 22-n are managed by the storage access control device 10 before the logical disks 21-1 to 21-m are generated. The VLDNs 22-1 to 22-n may not coincide with sections of physical disks forming the physical disk group 22.

The storage access control device 10 according to the present example embodiment provides, when generating a logical disk 21-i (i is a natural number of any of 1 to m), a logical disk number (LDN) to the generated logical disk 21-i to manage the logical disk 21-i.

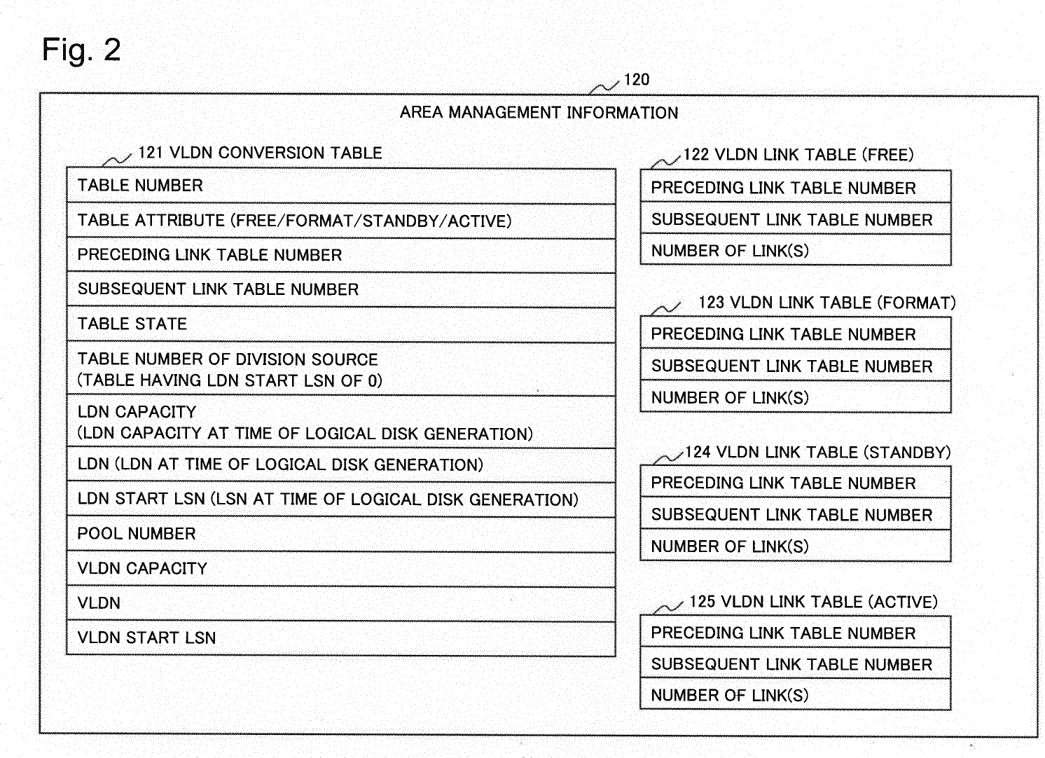

The storage unit 12 stores the area management information 120. The area management information 120 is information that manages each individual VLDN and associates a VLDN with an LDN. FIG. 2 is a diagram illustrating an example of a configuration of the area management information 120. As illustrated in FIG. 2, the area management information 120 includes a VLDN conversion table 121, a VLDN link table (free) 122, a VLDN link table (format) 123, a VLDN link table (standby) 124, and a VLDN link table (active) 125.

The VLDN conversion table 121 is a table indicating a state of each individual VLDN. A “table number” in the VLDN conversion table 121 is an identifier capable of identifying a VLDN. A “table attribute” is information indicating a state of a VLDN. The storage access control device 10 according to the present example embodiment sets a VLDN in any of four states including “free”, “format”, “standby”, and “active”. Details of these states will be described later.

The storage access control device 10 according to the present example embodiment performs link management on every group of VLDNs set in the same state among the four states. The link management is a method for linking VLDNs belonging to the group in order in a circular fashion (that is to say, connecting a last VLDN to a first VLDN) and thus managing the VLDNs belonging to the group in such a manner as to be logically connected to each other. Note that the storage access control device 10 may manage a VLDN by a method other than the link management. A “preceding link table number” and a “subsequent link table number” in the VLDN conversion table 121 are table numbers of a VLDN located (linked to) before and after the VLDN, respectively. A “table state” is information indicating an execution situation of formatting processing on a VLDN. An “LDN capacity” is a storage capacity of the logical disk 21-i specified by an LDN associated with a VLDN. A “VLDN capacity” is a storage capacity of a VLDN.

The VLDN link table (free) 122 is a table indicating the number of VLDNs in a free state (number of link(s)) and table numbers of a VLDN located before and after each individual VLDN in the free state. The VLDN link tables 123 to 125 are tables indicating the same contents of VLDNs in a format state, a standby state, and an active state, respectively, as those of the VLDN link table (free) 122.

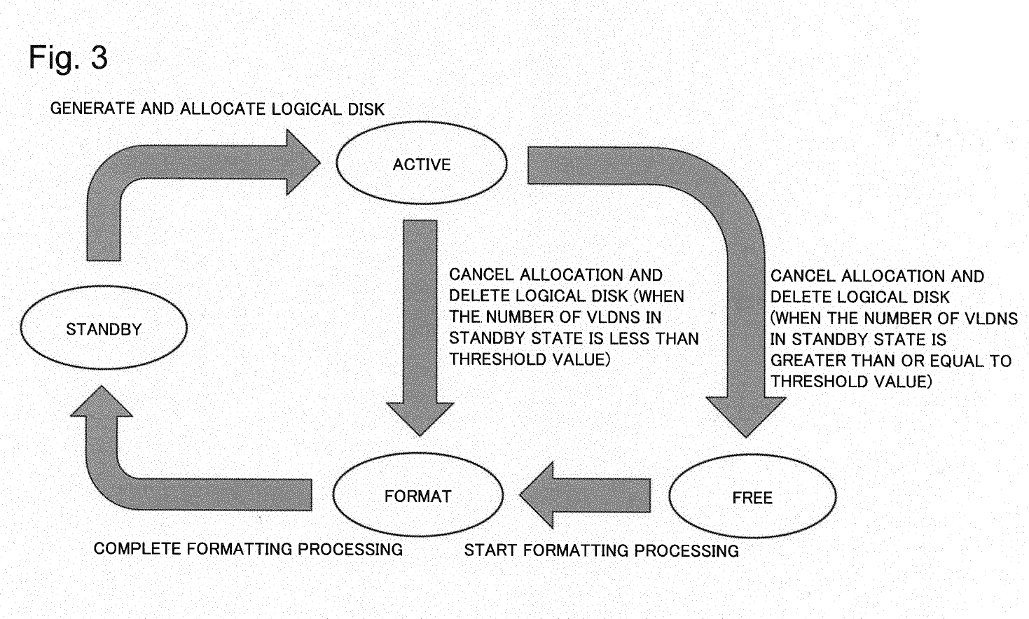

Herein, the above-described four states concerned with a VLDN will be described. FIG. 3 is an example of a state transition diagram concerned with the VLDNs 22-1 to 22-n according to the present example embodiment. The VLDNs 22-1 to 22-n are in the free state in an initial state. The storage access control device 10 constructs a pool by the physical disk group 22 and then starts formatting processing on at least any of the VLDNs 22-1 to 22-n. A VLDN on which the formatting processing is being prepared for execution or being executed makes a transition from the free state to the format state.

After completion of the formatting processing, a VLDN in the format state makes a transition to the standby state. The standby state is a state indicating that a VLDN has not yet been allocated as a logical disk and the formatting processing has been executed. In other words, the standby state is a state indicating that a VLDN can be allocated as a logical disk without requiring the formatting processing.

The storage access control device 10 allocates at least any of VLDNs in the standby state as a logical disk as necessary. A VLDN allocated as a logical disk makes a transition from the standby state to the active state. The active state is a state indicating that a VLDN has been allocated as a logical disk.

The storage access control device 10 deletes a logical disk or reduces a storage capacity thereof according to instructions from the host device 2. At this time, the VLDN allocated as the logical disk deleted or having a storage capacity reduced makes a transition to the free state or the format state depending on whether or not the number of VLDNs in the standby state is greater than or equal to a threshold value.

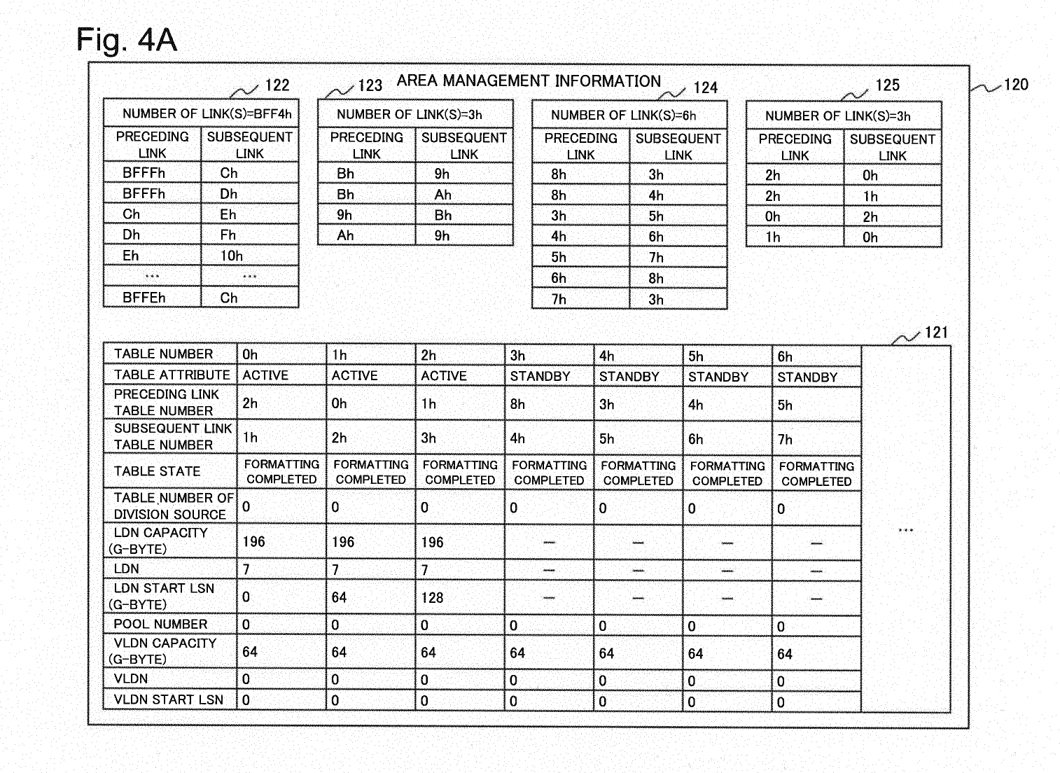

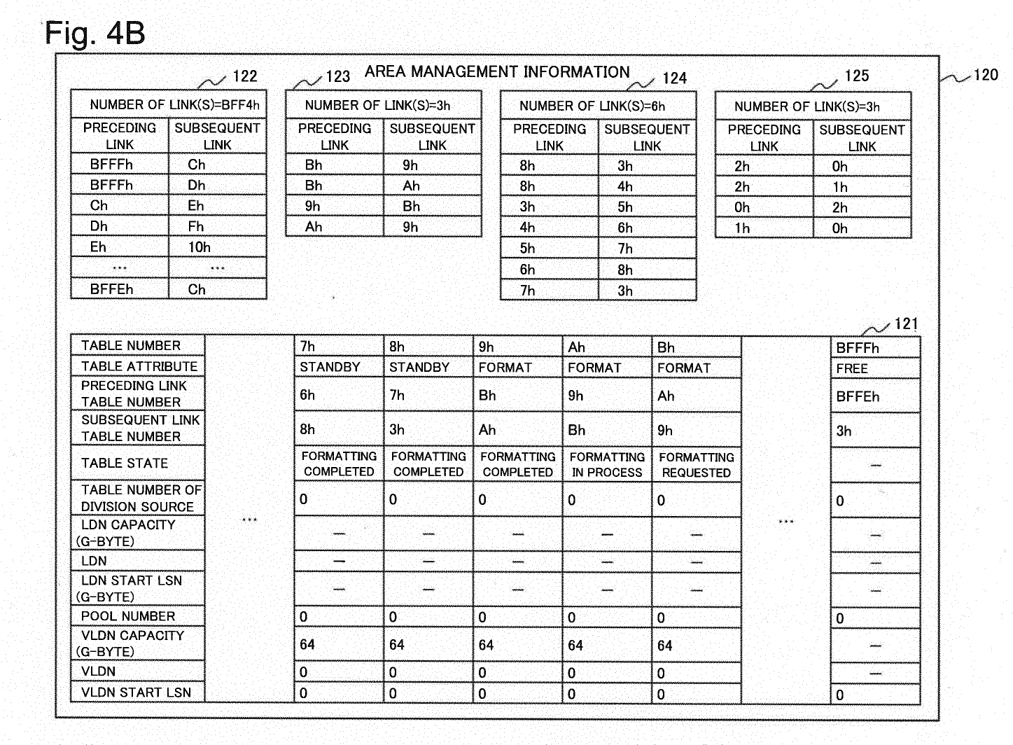

FIGS. 4A and 4B (in which the VLDN conversion table 121 is divided for the sake of a written expression of the drawings) are diagrams illustrating an example of setting the area management information 120 according to the present example embodiment. In the example illustrated in FIGS. 4A and 4B, a total storage capacity of the physical disk group 22 is 3 P-bytes (petabytes), and a storage capacity of each of the individual VLDNs 22-1 to 22-n is 64 G-bytes (gigabytes). In this case, a value of n is C000h (indicating that h is hexadecimal).

In the VLDN conversion table 121 in the example illustrated in FIGS. 4A and 4B, a table attribute of three VLDNs (hereinafter referred to as “VLDNs 0 to 2”) having 0h to 2h as table numbers is in the active state. As illustrated in the VLDN conversion table 121 and the VLDN link table (active) 125, the VLDNs 0 to 2 are linked in this order. Note that a record in a third row from the top in each of the link tables 122 to 125 illustrated in FIGS. 4A and 4B indicates VLDNs located at the end and first of a link. Since the VLDNs 0 to 2 are in the active state, the formatting processing has been completed as seen from the state transition diagram illustrated in FIG. 3. The VLDNs 0 to 2 are allocated as logical disks having “7” as an LDN and 196 G-bytes as a storage capacity.

In the VLDN conversion table 121 in the example illustrated in FIGS. 4A and 4B, a table attribute of six VLDNs (hereinafter referred to as “VLDNs 3 to 8”) having 3h to 8h as table numbers is in the standby state.

As illustrated in the VLDN conversion table 121 and the VLDN link table (standby) 124, the VLDNs 3 to 8 are linked in this order. Since the VLDNs 3 to 8 are in the standby state, the formatting processing has been completed. Note that “-” in the VLDN conversion table 121 is a symbol indicating that no value is set, and a portion described with “-” is set with a value not meant to be taken by the portion, for example.

In the VLDN conversion table 121 in the example illustrated in FIGS. 4A and 4B, a table attribute of three VLDNs (hereinafter referred to as “VLDNs 9 to B”) having 9h to Bh as table numbers is in the format state. As illustrated in the VLDN conversion table 121 and the VLDN link table (format) 123, the VLDNs 9 to B are linked in this order. The VLDNs 9 to B are respectively in situations of “formatting completed”, “formatting in process”, and “formatting requested” as execution situations of the formatting processing.

In the example illustrated in FIGS. 4A and 4B, it is assumed that other VLDNs having Ch (not illustrated for the sake of a written expression of the drawings) to BFFFh as table numbers excluding the above-described 12 VLDNs (namely, the VLDNs having 0h to Bh as the table numbers) are in the free state. As illustrated in the VLDN conversion table 121 and the VLDN link table (free) 122, the other VLDNs are linked in this order. The formatting processing is not performed on the other VLDNs.

The formatting execution unit 11 illustrated in FIG. 1 performs the formatting processing on the VLDNs 22-1 to 22-n before the VLDNs 22-1 to 22-n are allocated as logical disks 21-i (i is a natural number of at least any of 1 to m). The formatting execution unit 11 refers to the area management information 120 stored in the storage unit 12 at predetermined timing (for example, periodically) and checks whether or not the number of VLDNs in the standby state satisfies a criteria A. The criteria A represents, for example, “to be greater than or equal to a predetermined threshold value X”.

When the number of VLDNs in the standby state does not satisfy the criteria A, the formatting execution unit 11 performs the formatting processing on at least any of VLDNs 22-j (j is a natural number of at least any of 1 to m) in the free state in the area management information 120. After performing the formatting processing, the formatting execution unit 11 performs the formatting processing such that the number of VLDNs in the standby state can satisfy the criteria A. For example, when the number of VLDNs in the standby state is less than the criteria A by three, the formatting execution unit 11 performs the formatting processing on at least three of the VLDNs 22-j in the free state. The formatting execution unit 11 notifies the update unit 14 of an execution situation of the formatting processing.

The allocation control unit 13 illustrated in FIG. 1 controls allocation of the VLDNs 22-1 to 22-n as the logical disks 21-i and cancellation of the allocation. The allocation control unit 13 associates an LDN with a VLDN in the allocation processing. The allocation control unit 13 checks whether or not a writing address in a writing request to the storage device 20 issued from the host device 2 is present in the logical disk group 21. When the writing address is not present in the logical disk group 21, the allocation control unit 13 newly allocates the VLDN 22-j in the standby state in the area management information 120 as the logical disk 21-i including the writing address. The allocation control unit 13 notifies the update unit 14 of an execution situation of the allocation processing.

When the allocation control unit 13 receives a request to delete the logical disk 21-i in the storage device 20 or reduce a storage capacity thereof, which is issued from the host device 2, the allocation control unit 13 cancels the allocation of the VLDN 22-j allocated as the logical disk 21-i. In this way, the allocation control unit 13 deletes the logical disk 21-i or reduces the storage capacity thereof. The allocation control unit 13 notifies the host device 2 that the allocation control unit 13 has deleted the logical disk 21-i or reduced the storage capacity thereof.

The update unit 14 illustrated in FIG. 1 updates the area management information 120 stored in the storage unit 12 according to the processing performed on the VLDNs 22-1 to 22-n by the formatting execution unit 11 and the allocation control unit 13. The update unit 14 updates the VLDN conversion table 121 according to an execution situation of the formatting processing when the formatting execution unit 11 performs the formatting processing on at least any of the VLDNs 22-j in the free state. The update unit 14 updates a table attribute of the VLDN in the VLDN conversion table 121 from “free” to “format” and then further updates the table attribute from “format” to “standby”. The update unit 14 updates a table state of the VLDN in the VLDN conversion table 121 from “formatting requested” to “formatting in process” and then further updates the table state from “formatting in process” to “formatting completed”. The update unit 14 also updates the VLDN link tables 122 to 124 in conjunction with updating of the VLDN conversion table 121.

The update unit 14 updates the VLDN conversion table 121 according to an execution situation of the allocation processing when the allocation control unit 13 newly allocates the VLDN 22-j in the standby state as the logical disk 21-i including a writing address in a writing request issued from the host device 2. The update unit 14 updates a table attribute of the VLDN in the VLDN conversion table 121 from “standby” to “active”. The update unit 14 also updates the VLDN link tables 124 and 125 in conjunction with updating of the VLDN conversion table 121.

When the update unit 14 receives a request to delete the logical disk 21-i in the storage device 20 or reduce a storage capacity thereof, which is issued from the host device 2, the update unit 14 refers to the area management information 120 and checks whether or not the number of VLDNs in the standby state satisfies criteria B. The criteria B represents, for example, “to be greater than or equal to a predetermined threshold value Y”. Note that the criteria B may be the same as or different from the criteria A used in the formatting processing by the formatting execution unit 11.

When the number of VLDNs in the standby state satisfies the criteria B, the update unit 14 updates a table attribute of the VLDN 22-j allocated as the logical disk 21-i in the VLDN conversion table 121 from “active” to “free”. The update unit 14 also updates the VLDN link tables 122 and 125 in conjunction with updating of the VLDN conversion table 121.

When the number of VLDNs in the standby state does not satisfy the criteria B, the update unit 14 updates the table attribute of the VLDN 22-j allocated as the logical disk 21-i in the VLDN conversion table 121 from “active” to “format”. The update unit 14 also updates the VLDN link tables 123 and 125 in conjunction with updating of the VLDN conversion table 121. After the completion of the formatting processing on the VLDN 22-j by the formatting execution unit 11, the update unit 14 updates the table attribute of the VLDN 22-j in the VLDN conversion table 121 from “format” to “standby”. The update unit 14 also updates the VLDN link tables 123 and 124 in conjunction with updating of the VLDN conversion table 121.

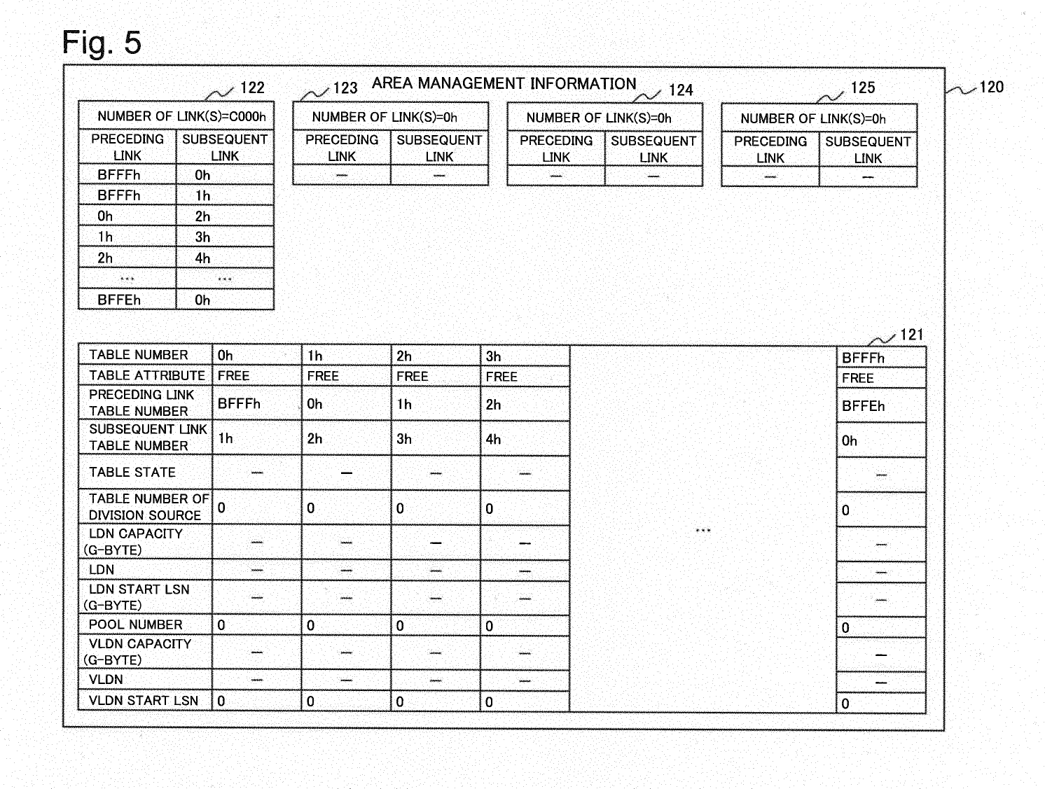

Examples of updating the area management information 120 by the update unit 14 will be described by using FIGS. 5 to 10. FIG. 5 is a diagram illustrating an example of an initial state of the area management information 120. Also in the examples illustrated in FIGS. 5 to 10, similarly to the example illustrated in FIGS. 4A and 4B, a total storage capacity of the physical disk group 22 is 3 P-bytes, and a storage capacity of each of the individual VLDNs 22-1 to 22-n is 64 G-bytes. As illustrated in FIG. 5, all the VLDNs are in the free state in the initial state.

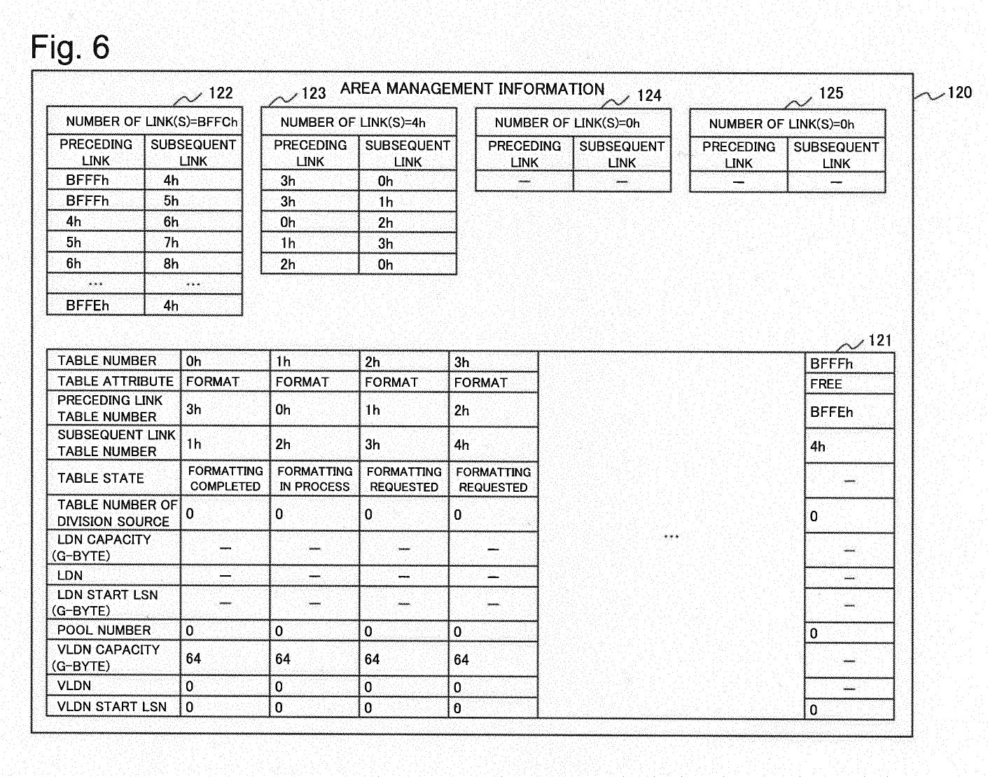

FIG. 6 is a diagram illustrating the area management information 120 updated by the update unit 14 in a case where the formatting execution unit 11 performs the formatting processing on four VLDNs (hereinafter referred to as “VLDNs 0 to 3”) having 0h to 3h, respectively, as table numbers when the VLDNs 22-1 to 22-n are in the state illustrated in FIG. 5. As illustrated in FIG. 6, contents of the VLDNs 0 to 3 are updated from the free state to the format state.

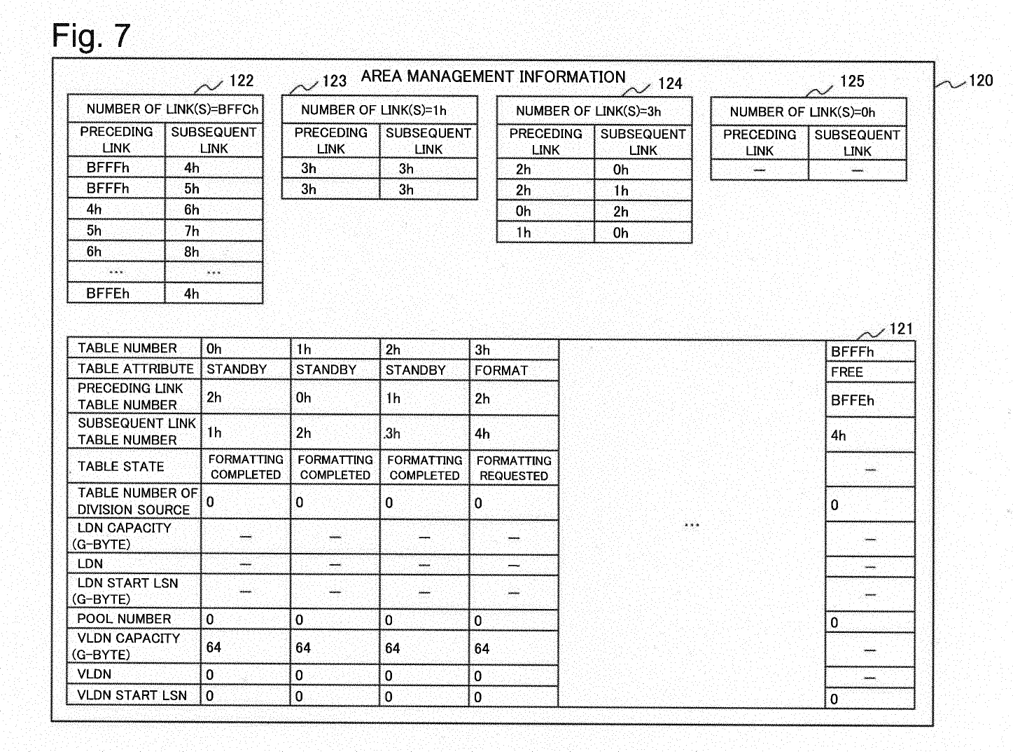

FIG. 7 is a diagram illustrating the area management information 120 updated by the update unit 14 after the completion of the formatting processing on the VLDNs 0 to 2 when the VLDNs 22-1 to 22-n are in the state illustrated in FIG. 6. As illustrated in FIG. 7, contents of the VLDNs 0 to 2 are updated from the format state to the standby state.

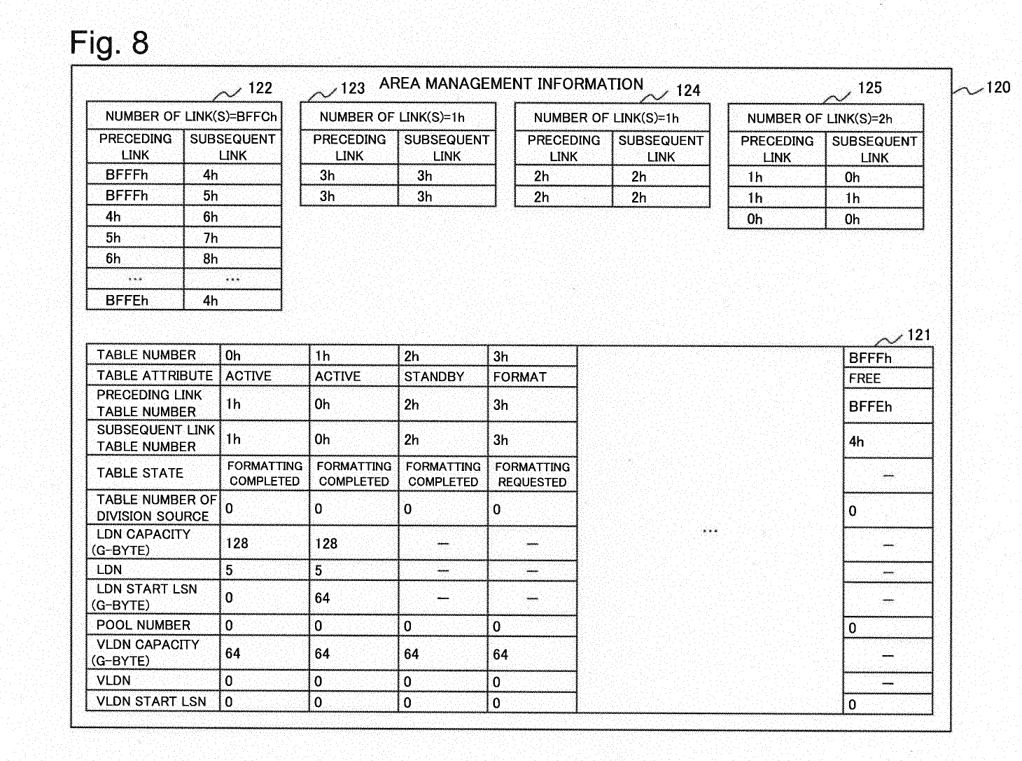

FIG. 8 is a diagram illustrating the area management information 120 updated by the update unit 14 in a case where the allocation control unit 13 allocates the VLDNs 0 and 1 to the logical disks 21-i when the VLDNs 22-1 to 22-n are in the state illustrated in FIG. 7. As illustrated in FIG. 8, contents of the VLDNs 0 and 1 are updated from the standby state to the active state. As illustrated in FIG. 8, the VLDNs 0 and 1 are allocated as logical disks each having “5” as an LDN and 128 G-bytes as a storage capacity.

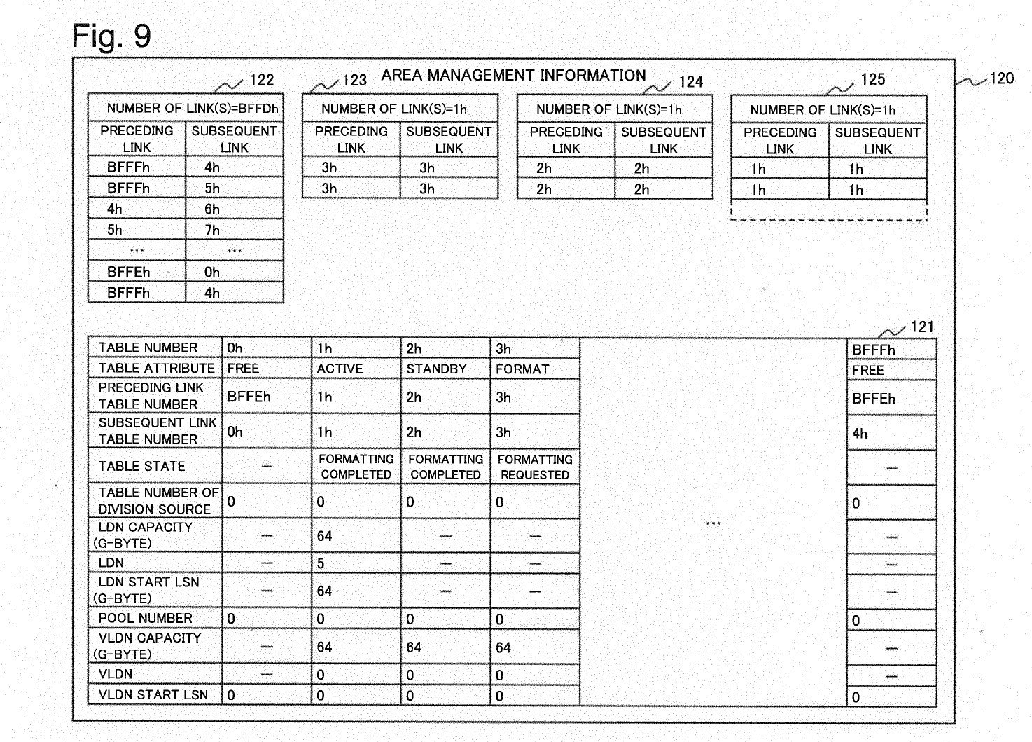

FIG. 9 is a diagram illustrating the area management information 120 updated by the update unit 14 in a case where the allocation of the VLDN 0 to the logical disk 21-i by the allocation control unit 13 is canceled when the VLDNs 22-1 to 22-n are in the state illustrated in FIG. 8. Note that FIG. 9 is a diagram illustrating the area management information 120 updated when the number of VLDNs in the standby state satisfies the criteria B. As illustrated in FIG. 9, a content of the VLDN 0 is updated from the active state to the free state. Further, the storage capacity of the logical disk 21-i is updated from 128 G-bytes to 64 G-bytes.

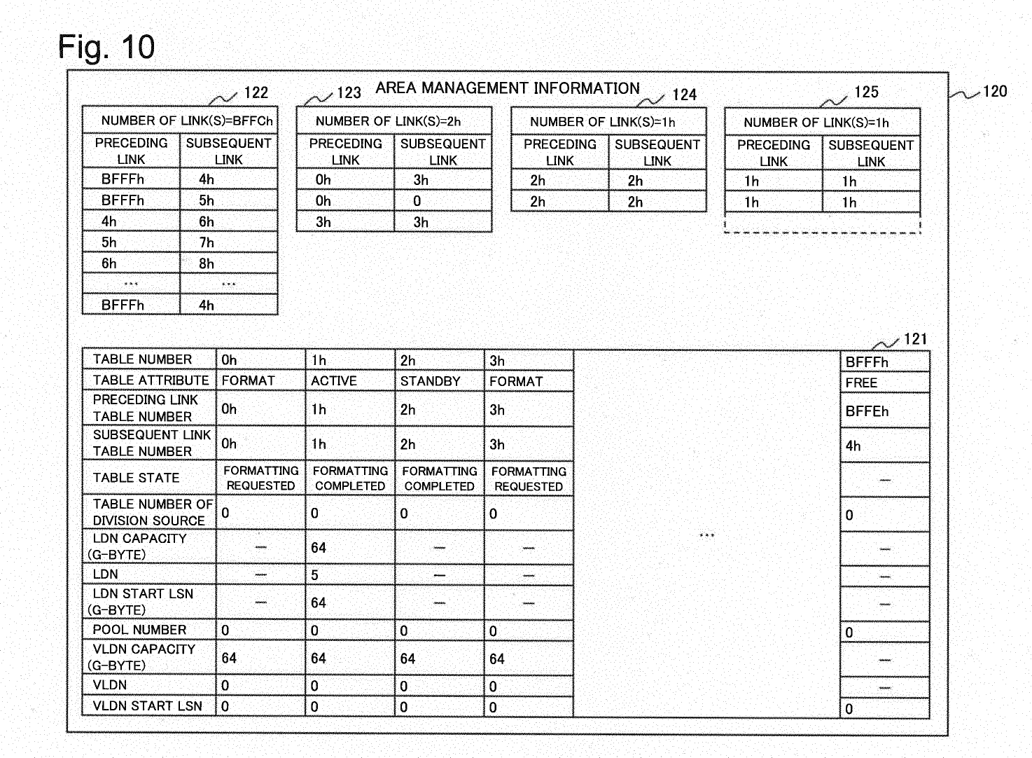

FIG. 10 is a diagram illustrating the area management information 120 updated by the update unit 14 in a case where the allocation of the VLDN 0 to the logical disk 21-i by the allocation control unit 13 is canceled when the VLDNs 22-1 to 22-n are in the state illustrated in FIG. 8. Note that FIG. 10 is a diagram illustrating the area management information 120 updated when the number of VLDNs in the standby state does not satisfy the criteria B. As illustrated in FIG. 10, the content of the VLDN 0 is updated from the active state to the format state.

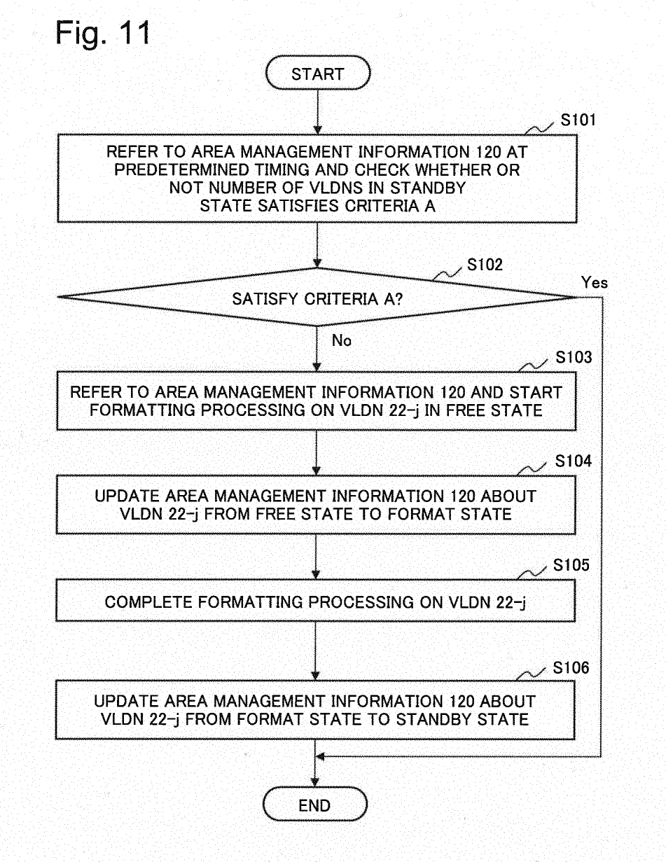

Next, an operation (processing) of the storage access control device 10 according to the present example embodiment will be described in detail with reference to flowcharts of FIGS. 11 to 13.

FIG. 11 is a flowchart illustrating an operation when the storage access control device 10 according to the present example embodiment performs formatting processing on a VLDN at predetermined timing.

The formatting execution unit 11 refers to the area management information 120 at predetermined timing and checks whether or not the number of VLDNs in the standby state satisfies the criteria A (Step S101). When the number of VLDNs in the standby state satisfies the criteria A (Yes in Step S102), the whole processing is terminated. When the number of VLDNs in the standby state does not satisfy the criteria A (No in Step S102), the formatting execution unit 11 refers to the area management information 120 and starts the formatting processing on the VLDN 22-j in the free state (Step S103).

The update unit 14 updates the area management information 120 regarding the VLDN 22-j from the free state to the format state (Step S104). The formatting execution unit 11 completes the formatting processing on the VLDN 22-j (Step S105). The update unit 14 updates the area management information 120 regarding the VLDN 22-j from the format state to the standby state (Step S106), and the whole processing is terminated.

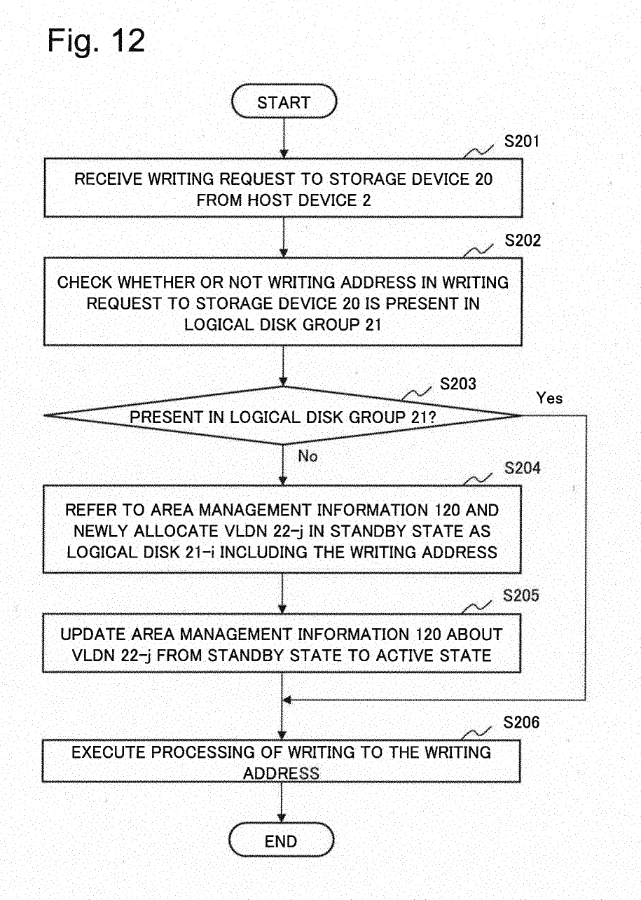

FIG. 12 is a flowchart illustrating an operation when the storage access control device 10 according to the present example embodiment receives a writing request to the storage device 20 from the host device 2.

The storage access control device 10 receives a writing request to the storage device 20 from the host device 2 (Step S201). The allocation control unit 13 checks whether or not a writing address in the writing request to the storage device 20 is present in the logical disk group 21 (Step S202). When the writing address is present in the logical disk group 21 (Yes in Step S203), the processing proceeds to Step S206.

When the writing address is not present in the logical disk group 21 (No in Step S203), the allocation control unit 13 refers to the area management information 120 and newly allocates the VLDN 22-j in the standby state as the logical disk 21-i including the writing address (Step S204). The update unit 14 updates the area management information 120 regarding the VLDN 22-j from the standby state to the active state (Step S205). The storage access control device 10 executes processing of writing to the writing address (Step S206), and the whole processing is terminated.

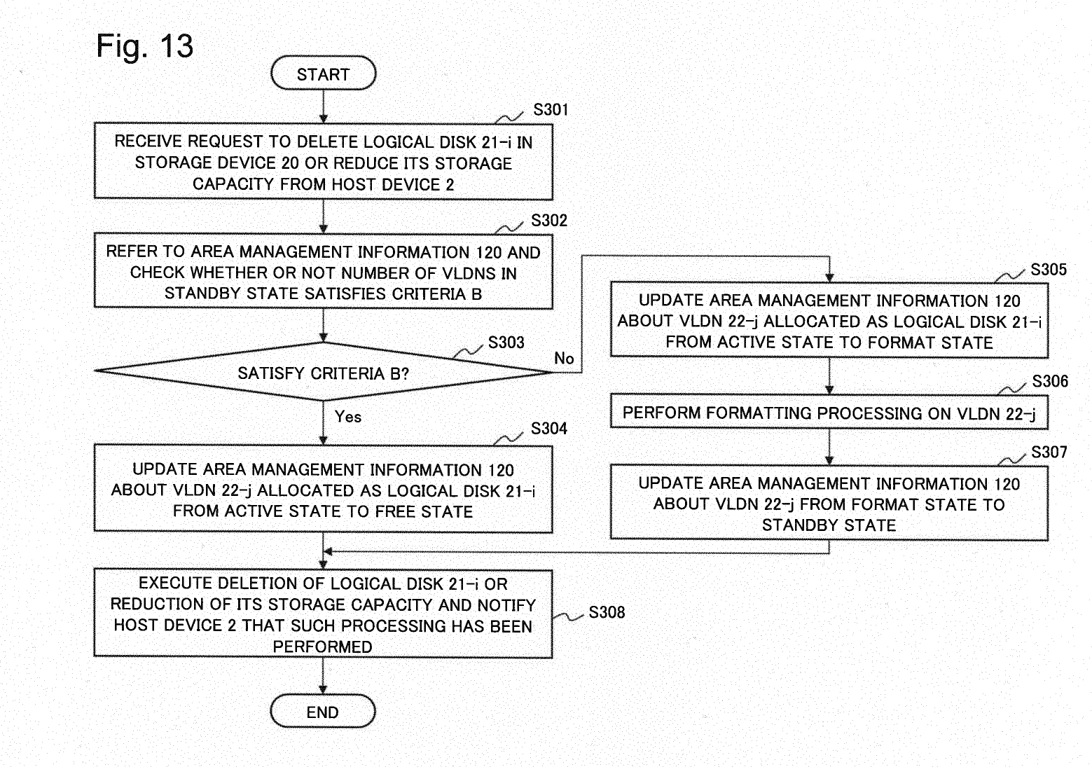

FIG. 13 is a flowchart illustrating an operation when the storage access control device 10 according to the present example embodiment receives, from the host device 2, a request to delete a logical disk or reduce a storage capacity thereof.

The storage access control device 10 receives, from the host device 2, a request to delete the logical disk 21-i in the storage device 20 or reduce a storage capacity thereof (Step S301). The update unit 14 refers to the area management information 120 and checks whether or not the number of VLDNs in the standby state satisfies the criteria B (Step S302). When the number of VLDNs in the standby state satisfies the criteria B (Yes in Step S303), the update unit 14 updates the area management information 120 regarding the VLDN 22-j allocated as the logical disk 21-i from the active state to the free state (Step S304).

When the number of VLDNs in the standby state does not satisfy the criteria B (No in Step S303), the update unit 14 updates the area management information 120 regarding the VLDN 22-j allocated as the logical disk 21-i from the active state to the format state (Step S305). The formatting execution unit 11 performs the formatting processing on the VLDN 22-j (Step S306). The update unit 14 updates the area management information 120 regarding the VLDN 22-j from the format state to the standby state (Step S307). The allocation control unit 13 executes deletion of the logical disk 21-i or reduction of the storage capacity thereof and notifies the host device 2 that such processing has been performed (Step S308), and the whole processing is terminated.

The storage access control device 10 according to the present example embodiment can improve performance of responding to write access to a storage device that needs formatting processing. The reason is that the formatting execution unit 11 performs the formatting processing on a physical storage area (VLDN) in the storage device 20 at predetermined timing before the VLDN is allocated as a logical storage area (logical disk). The allocation control unit 13 then allocates, as a logical storage area, a physical storage area that has already undergone the formatting processing and has not yet been allocated as the logical storage area.

An effect achieved by the storage access control device 10 according to the present example embodiment will be described below in detail.

Protection information is generally added to data stored in a storage device to increase reliability. For example, a sector number of a logical disk and the like are used as the protection information. Therefore, formatting processing on a storage area of a physical disk is usually performed after a logical disk is generated. Then, a host device accessing the storage device may issue a writing request to a logical address in a storage area that has not yet undergone the formatting processing. In this case, a storage access control device needs to perform the formatting processing while processing the writing request, and thus, there is a problem that performance of responding to write access to the storage device decreases.

In contrast, in the storage access control device 10 according to the present example embodiment, the formatting execution unit 11 performs the formatting processing on at least any of a plurality of VLDNs in the storage device 20 before the VLDN is allocated as a logical disk to which the host device 2 can make access. The storage unit 12 stores the area management information 120 indicating, as a state of each of the individual VLDNs, whether or not the VLDN has been allocated as a logical disk and whether or not the formatting processing has been executed. Upon occurrence of access to a logical storage area to which the VLDN has not yet been allocated, the allocation control unit 13 allocates a VLDN that has not yet been allocated as the logical storage area and has already undergone the formatting processing (that is to say, is in the standby state) in the area management information 120 as a logical disk of the access destination. The update unit 14 updates the area management information 120 stored in the storage unit 12 according to the processing performed on the VLDN by the formatting execution unit 11 and the allocation control unit 13. In this way, the storage access control device 10 according to the present example embodiment can improve the performance of responding to write access to the storage device that needs the formatting processing.

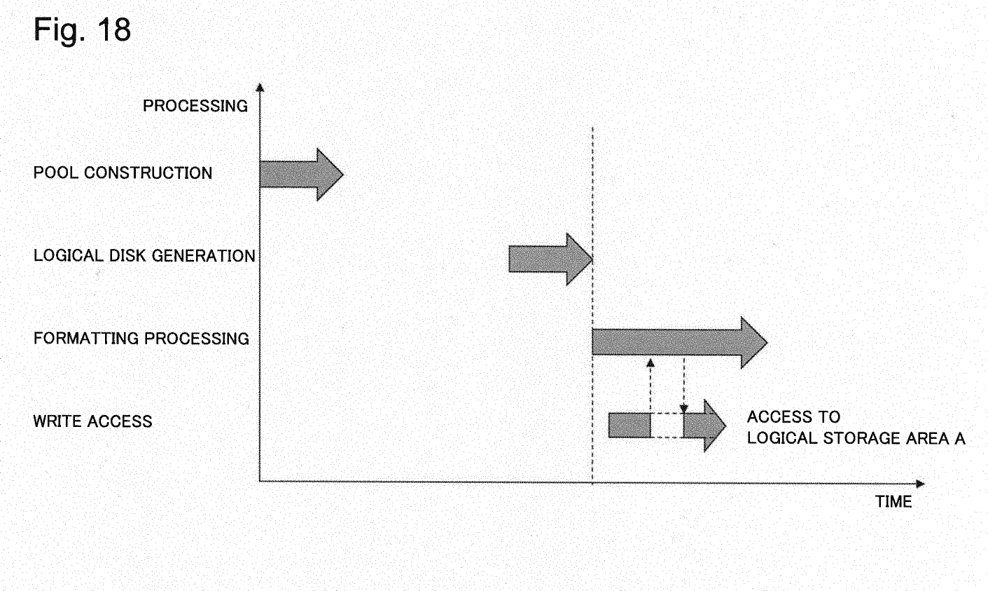

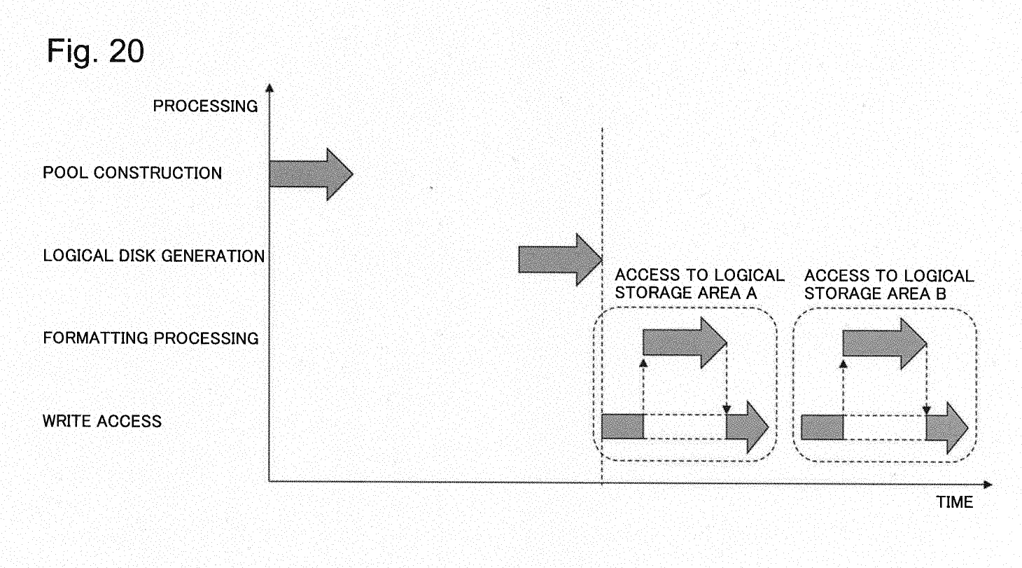

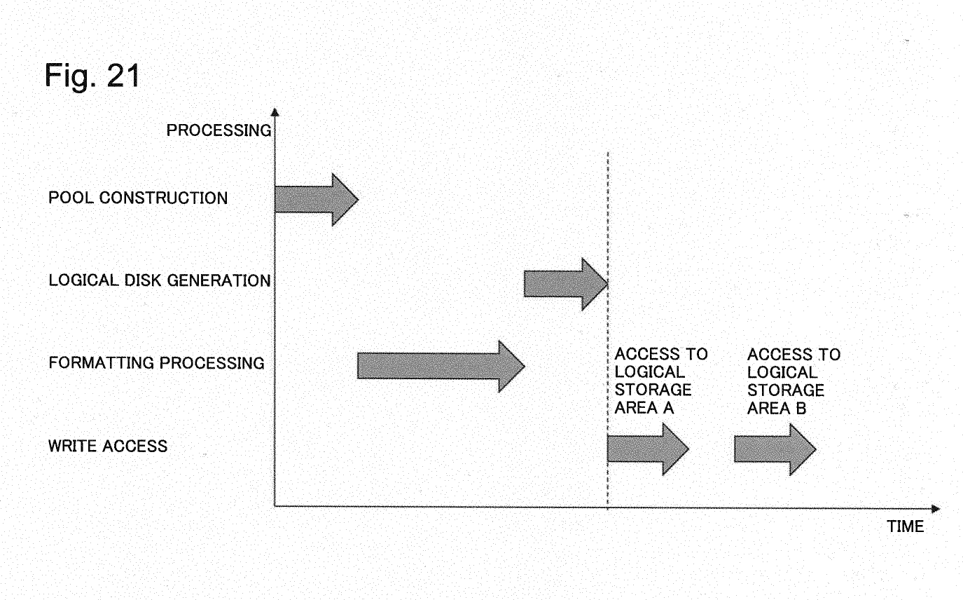

FIG. 21 is an example of a time chart of storage access control processing performed by the storage access control device 10 according to the present example embodiment. As illustrated in FIG. 21, the storage access control device 10 according to the present example embodiment does not need to perform the formatting processing while processing a writing request, unlike the general storage access control device illustrated in FIG. 18 or 20. Therefore, the storage access control device 10 can improve performance of responding to write access to the storage device.

Further, in the storage access control device 10 according to the present example embodiment, the formatting execution unit 11 refers to the area management information 120 at predetermined timing (for example, periodically). When the number of VLDNs in the standby state indicated by the area management information 120 does not satisfy criteria, the storage access control device 10 performs the formatting processing on at least any of the VLDNs 22-1 to 22-n. In this way, the storage access control device 10 according to the present example embodiment can promptly allocate a VLDN as a logical disk by keeping the number of the VLDN in the standby state equal to or greater than that of the criteria.

Further, in the storage access control device 10 according to the present example embodiment, there is a case when allocation of any of VLDNs as a logical disk is canceled. When the number of VLDNs in the standby state indicated by the area management information 120 does not satisfy criteria, the update unit 14 updates a state of the VLDN having the allocation as the logical disk canceled from the active state to the format state. When the number of VLDNs in the standby state satisfies the criteria, the update unit 14 updates a state of the VLDN having the allocation as the logical disk canceled from the active state to the free state. Therefore, the storage access control device 10 according to the present example embodiment can promptly allocate a VLDN as a logical disk by keeping the number of the VLDN in the standby state equal to or greater than that of the criteria.

Note that in the storage access control device 10 according to the present example embodiment, the storage unit 12 may add or delete a VLDN as a management target of the area management information 120 any time according to a storable capacity of a device implemented in the storage device 20, an usage situation of the storage device 20, or the like. In this way, the storage access control device 10 according to the present example embodiment can act flexibly even when a storable capacity of the storage device 20 is changed.

### Second Example Embodiment

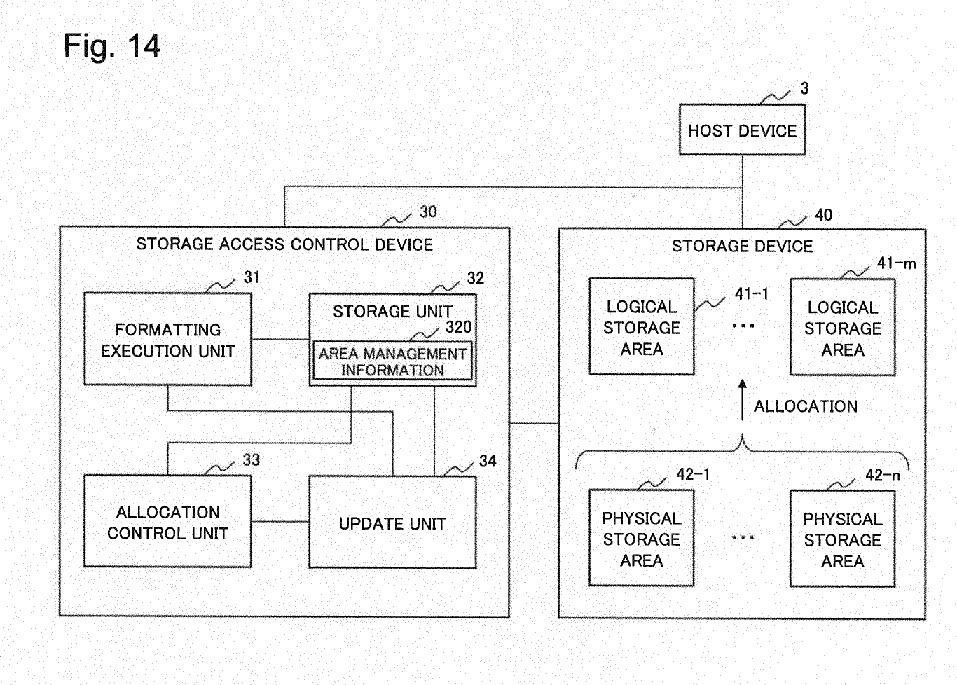

FIG. 14 is a block diagram schematically illustrating a configuration of a storage access control device 30 according to a second example embodiment.

The storage access control device 30 according to the present example embodiment includes a formatting execution unit 31, a storage unit 32, an allocation control unit 33, and an update unit 34.

The formatting execution unit 31 performs formatting processing on at least any of a plurality of physical storage areas 42-1 to 42-n (n is an arbitrary integer of two or more) in a storage device 40 before the physical storage area is allocated as a logical storage area accessible from a host device 3 accessing the storage device 40.

The storage unit 32 stores area management information 320 indicating a state of each of the individual physical storage areas 42-1 to 42-n as to whether or not the physical storage area has been allocated as any of a plurality of logical storage areas 41-1 to 41-m (m is an arbitrary integer of two or more) and whether or not the formatting processing has been executed.

Upon occurrence of access by the host device 3 to a specific logical storage area 41-i (i is a natural number of any of 1 to m) to which none of the plurality of physical storage areas 42-1 to 42-n has been allocated, the allocation control unit 33 allocates a first physical storage area 42-j (j is a natural number of at least any of 1 to n) as the specific logical storage area 41-i. The first physical storage area 42-j is a physical storage area in the standby state indicated by the area management information 320 that has not yet been allocated as the logical storage area and has already undergone the formatting processing.

The update unit 34 updates the area management information 320 stored in the storage unit 32 according to the processing performed on the physical storage areas 42-1 to 42-n by the formatting execution unit 31 and the allocation control unit 33.

The storage access control device 30 according to the present example embodiment can improve performance of responding to write access to a storage device that needs formatting processing. The reason is that the formatting execution unit 31 performs the formatting processing on a physical storage area in the storage device 40 before the physical storage area is allocated as a logical storage area. The allocation control unit 33 allocates, as a logical storage area, a physical storage area that has already undergone the formatting processing and has not yet been allocated as a logical storage area.

### <Example of Hardware Configuration>

Each of the units illustrated in FIGS. 1 and 14 in each of the example embodiments described above can be achieved by dedicated hardware (HW) (electronic circuit). Further, in FIGS. 1 and 14, at least configurations stated below can be regarded as functional (processing) units (software modules) of a software program.
Formatting execution units 11 and 31
Storage control function in storage units 12 and 32
Allocation control units 13 and 33
Update units 14 and 34

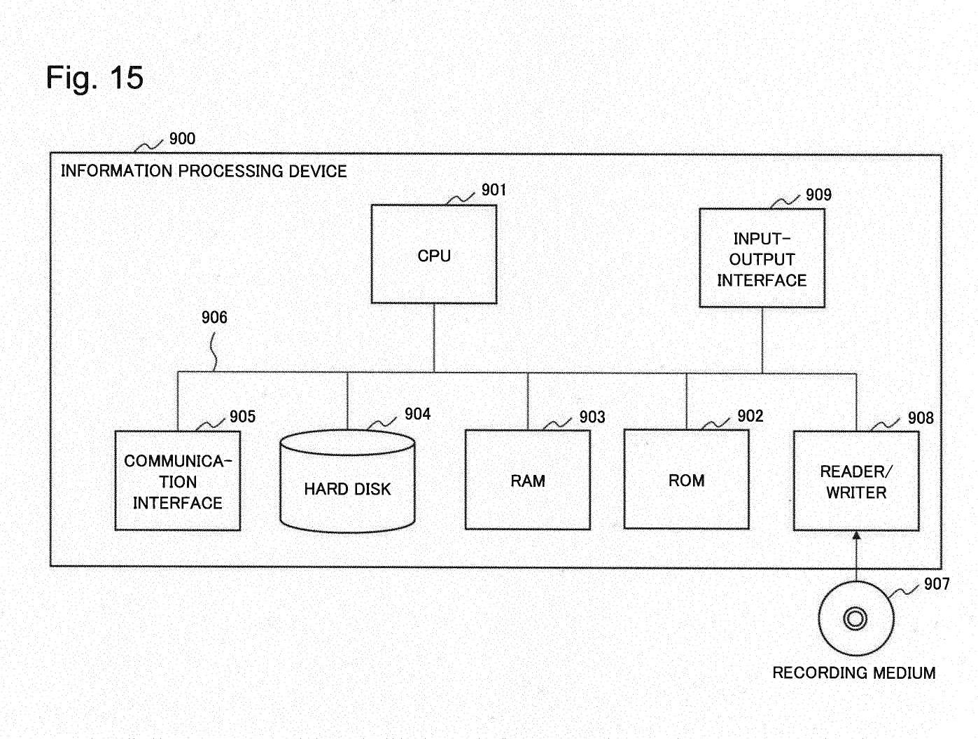

However, a division of each of the units illustrated in the drawings is a configuration for convenience of description, and various configurations are assumable for implementation. An example of a hardware environment in this case will be described with reference to FIG. 15.

FIG. 15 is a diagram for exemplifying and describing a configuration of an information processing device 900 (computer) capable of executing the storage access control device according to each of the example embodiments of the present invention. In other words, FIG. 15 illustrates a configuration of a computer (information processing device) capable of achieving the storage access control device illustrated in FIGS. 1 and 14 and a hardware environment in which each of the functions in the above-described example embodiments can be achieved.

The information processing device 900 illustrated in FIG. 15 includes the following as structural components.
A Central Processing Unit (CPU) 901
A Read Only Memory (ROM) 902
A Random Access Memory (RAM) 903
A hard disk (storage device) 904
A communication interface 905 with an external device
A bus 906 (communication line)
A reader/writer 908 capable of reading and writing data stored in a recording medium 907 such as a Compact Disk Read Only Memory (CD-ROM)
An input-output interface 909

In other words, the information processing device 900 including the structural components above is a general computer in which these configurations are connected to one another via the bus 906. The information processing device 900 may include a plurality of CPUs 901 or may include the CPU 901 formed by a multi-core.

Then, the present invention described by taking the above-described example embodiments as an example supplies a computer program capable of achieving the following functions to the information processing device 900 illustrated in FIG. 15. The functions are the above-described configurations in the block configuration diagrams (FIGS. 1 and 14) which are referred to in the description of the example embodiments or the functions in the flowcharts (FIGS. 11 to 13). The present invention is then achieved by causing the CPU 901 of the hardware to read, interpret, and execute the computer program. Further, the computer program supplied to the inside of the device may be stored in a volatile memory (RAM 903) capable of reading and writing or a non-volatile storage device such as the hard disk 904.

In addition, a general procedure can be currently adopted as a method for supplying a computer program to the inside of the hardware in the above-mentioned case. Examples of the procedure include a method for installing a computer program in the device via various recording media 907 such as a CD-ROM and a method for downloading a computer program from the outside via a communication line such as the Internet. Then, in such a case, it can be understood that the present invention includes a code forming the computer program or the recording medium 907 in which the code is stored.

The invention of the present application has been described so far with the above example embodiments by way of model example. However, the invention of the present application is not limited to the example embodiments described above. In other words, various aspects that can be understood by a person skilled in the art are applicable to the invention of the present application within the scope of the invention of the present application.

This application is based upon and claims the benefit of priority from Japanese patent application No. 2016-010472, filed on Jan. 22, 2016, the disclosure of which is incorporated herein in its entirety by reference.

### REFERENCE SIGNS LIST

1 Storage access control system
10 Storage access control device
11 Formatting execution unit
12 Storage unit
120 Area management information
121 VLDN conversion table
122 VLDN link table (free)
123 VLDN link table (format)
124 VLDN link table (standby)
125 VLDN link table (active)
13 Allocation control unit
14 Update unit
20 Storage device
21 Logical disk group
21-1 to 21-m Logical disk
22 Physical disk group
22-1 to 22-n VLDN
2 Host device
30 Storage access control device
31 Formatting execution unit
32 Storage unit
320 Area management information
33 Allocation control unit
34 Update unit
40 Storage device
41-1 to 41-m Logical storage area
42-1 to 42-n Physical storage area
3 Host device
50 Storage device
51 Logical disk
52 Physical disk group
60 Storage device
61 Logical disk
62 Physical disk group
900 Information processing device
901 CPU
902 ROM
903 RAM
904 Hard disk (storage device)
905 Communication interface
906 Bus
907 Recording medium
908 Reader/writer
909 Input-output interface

What is claimed is:

1. A storage access control device comprising:
a storage unit configured to store area management information indicating, with regard to a state of each of a plurality of physical storage areas in a storage device, any of a standby state representing that the physical storage area is not yet allocated as a logical storage area accessible from a host device accessing the storage device and that formatting processing is already executed, an active state representing that the physical storage area is already allocated as the logical storage area, a format state representing that the formatting processing is being prepared for execution or being executed, and a free state representing that the formatting processing is not yet executed and the physical storage area is not being in the format state;
a formatting execution unit configured to perform the formatting processing on at least any of a plurality of the physical storage areas in the free state before the physical storage area is allocated as the logical storage area;
an allocation control unit configured to allocate, upon occurrence of access by the host device to a specific logical storage area(s) of the logical storage areas to which none of the plurality of physical storage areas is allocated, a first one of the physical storage areas in the standby state as the specific logical storage area; and
an update unit configured to update the area management information stored in the storage unit according to processing performed on the physical storage area by the formatting execution unit and the allocation control unit.

2. (canceled)

3. The storage access control device according to claim 1, wherein
the formatting execution unit refers to the area management information at predetermined timing, and performs the formatting processing on at least any of the physical storage areas in the free state when a number of the physical storage areas in the standby state indicated by the area management information does not satisfy first criteria.

4. The storage access control device according to claim 3, wherein
the allocation control unit cancels allocation of a second one of the physical storage areas in the active state as the logical storage area according to an instruction from the host device, and
the update unit updates a state of the second physical storage area from the active state to the format state when the number of the physical storage areas in the standby state indicated by the area management information does not satisfy second criteria, and updates the state of the second physical storage area from the active state to the free state when the number of the physical storage areas in the standby state indicated by the area management information satisfies the second criteria.

5. The storage access control device according to claim 1, wherein
the storage means adds or deletes the physical storage area that is a management target of the area management information any time according to a storable capacity of a device implemented in the storage device or an usage situation of the storage device.

6. A storage access control system comprising:
the storage access control device including a storage unit, a formatting execution unit, an allocation control unit, and an update unit, wherein
the storage unit is configured to store area management information indicating, with regard to a state of each of a plurality of physical storage areas in a storage device, any of a standby state representing that the physical storage area is not yet allocated as a logical storage area accessible from a host device accessing the storage device and that formatting processing is already executed, an active state representing that the physical storage area is already allocated as the logical storage area, a format state representing that the formatting processing is being prepared for execution or being executed, and a free state representing that the formatting processing is not yet executed and the physical storage area is not being in the format state;
the formatting execution unit is configured to perform the formatting processing on at least any of a plurality of the physical storage areas in the free state before the physical storage area is allocated as the logical storage area;
the allocation control unit is configured to allocate, upon occurrence of access by the host device to a specific one of the logical storage areas to which none of the plurality of physical storage areas is allocated, a first one of the physical storage areas in the standby state as the specific logical storage area; and
the update unit is configured to update the area management information stored in the storage unit according to processing performed on the physical storage area by the formatting execution unit and the allocation control unit; and
the storage device.

7. A storage access control method comprising, by an information processing device:
storing area management information indicating in storage unit, with regard to a state of each of a plurality of physical storage areas in a storage device, any of a standby state representing that the physical storage area is not yet allocated as a logical storage area accessible from a host device accessing the storage device and that formatting processing is already executed, an active state representing that the physical storage area is already allocated as the logical storage area, a format state representing that the formatting processing is being prepared for execution or being executed, and a free state representing that the formatting processing is not yet executed and the physical storage area is not being in the format state;
performing the formatting processing on at least any of a plurality of the physical storage areas in the free state before the physical storage area is allocated as the logical storage area;
allocating, upon occurrence of access by the host device to a specific logical storage area(s) of the logical storage areas to which none of the plurality of physical storage areas is allocated, a first one of the physical storage areas in the standby state as the specific logical storage area; and
updating the area management information stored in the storage unit according to processing performed on the physical storage area.

8. The storage access control method according to claim 7 further comprising
referring to the area management information at predetermined timing, and
performing the formatting processing on at least any of the physical storage areas in the free state when a number of the physical storage areas in the standby state indicated by the area management information does not satisfy first criteria.

9. A non-transitory computer readable recording medium in which a storage access control program is stored, the program causing a computer accessible to a storage unit that stores area management information indicating with regard to a state of each of a plurality of physical storage areas in a storage device, any of a standby state representing that the physical storage area is not yet allocated as a logical storage area accessible from a host device accessing the storage device and that formatting processing is already executed, an active state representing that the physical storage area is already allocated as the logical storage area, a format state representing that the formatting processing is being prepared for execution or being executed, and a free state representing that the formatting processing is not yet executed and the physical storage area is not being in the format state, to execute:
formatting execution processing of performing the formatting processing on at least any of the plurality of physical storage areas in the free state before the physical storage area is allocated as the logical storage area;
allocation control processing of allocating, upon occurrence of access by the host device to a specific logical storage area(s) of the logical storage areas to which none of the plurality of physical storage areas is allocated, a first one on the physical storage areas in the standby state as the specific logical storage area; and
update processing of updating the area management information stored in the storage unit according to processing performed on the physical storage area by the formatting execution processing and the allocation control processing.

10. The recording medium in which the storage access control program according to claim 9 is stored, wherein
the formatting execution processing refers to the area management information at predetermined timing, and performs the formatting processing on at least any of the physical storage areas in the free state when a number of the physical storage areas in the standby state indicated by the area management information does not satisfy first criteria.
